(19) United States
(12) Patent Application Publication
(10) Pub. No.: US 2026/0324564 A1
(43) Pub. Date: Oct. 22, 2026

(54) HARVESTER HEAD ROTATOR WITH ROTATION ANGLE SENSOR

(71) Applicant: Deere & Company, Moline, IL (US)

(72) Inventor: Aki Solala, Tampere (FI)

(21) Appl. No.: 19/562,244

(22) Filed: Mar. 10, 2026

(30) Foreign Application Priority Data
Apr. 17, 2025 (EP) 25171374.9

(51) Int. Cl. A01G 23/00; G01D 5/14

(52) U.S. Cl. CPC A01G 23/003; G01D 5/14

(57) ABSTRACT

A harvester includes a crane, a harvest head, and an assembly positioned between a distal end of the crane and the harvester head. The assembly includes a rotator for the harvester head. The rotator comprises a stator, a rotor, and a sensor. The stator is configured to be mounted to a distal end of the crane of the harvester head. The rotor is configured to be mounted to the distal end of the crane of the harvester head. The sensor is configured to detect an angular position of the rotor about the axis, wherein the sensor is mounted to an intermediate flange mounted between the rotor and the frame of the harvester head. The sensor is also configured to interact with a reference element mounted on the stator.

### CROSS REFERENCE TO RELATED APPLICATIONS

This application claims priority under 35 U.S.C. § 119 to European patent application EP 25171374.9, filed on 17 Apr. 2025, the disclosure of which is incorporated herein by reference.

### FIELD OF THE DISCLOSURE

The present disclosure generally relates to a forwarder.

### BACKGROUND OF THE DISCLOSURE

In forestry operations, trees at a worksite are commonly felled, delimbed, and crosscut to a desired length or into logs using a forest harvester. The forest harvester may be a self-propelled machine that includes a harvester head mounted to an articulated boom. During crosscutting, logs are ejected from the harvester head and deposited at the worksite, for example along a travel route of the harvester, where the logs may be arranged in one or more piles. The piles may be sorted according to predefined characteristics of the logs, such as tree species or timber assortment. The logs are subsequently collected and transported, for example by a forwarder.

The forwarder is a self-propelled vehicle including an articulated boom with head on a which a grapple is attached for grabbing one or more logs at a time and a loading space that is surrounded by posts into which the collected logs are deposited. Once the loading space is sufficiently filled, the forwarder drives to a forest depot which may be adjacent to a logging road and deposits the logs in single or multiple piles. In particular, the logs are sorted according to the defined properties of the logs. The logs are later collected by trucks and transported to a processing plant such as a sawmill or a paper factory.

When working with a forwarder, a typical task to be performed with the boom is to transfer logs from locations outside of the loading space to the inside of the loading space and lower the grapple for depositing the logs. Another typical task to be performed with the boom after depositing the logs into the loading space is to move the empty grapple from the loading space back to a location outside the loading space where logs to be loaded have been collected into a pile.

The boom of the forwarder is provided with a number of actuators for allowing a three-dimensional movement of the distal end of the boom and thus the grapple to grab a log and move it from its original position to a desired position. Traditionally, all these actuators are controlled by an operator, usually via one or more joysticks with switches. The operator thus controls the angle of the proximal end of the boom around the vertical axis with respect to the chassis of the forwarder, the inclination of the proximal end of the boom around a horizontal axis, an articulation angle of a telescoping jib at the distal area of the boom, the length of the telescoping jib and the rotation angle of the grapple, and finally to opening and closing of the grapple.

For control of actuators controlling the movement of the boom based on manual control inputs by an operator, which operator inputs are used to teach an automated, learned boom control that subsequently repeats the learned commands, reference is made to the prior art described in EP 4 470 363 A. In this reference, no automatic control of the actuator that rotates the grapple around the vertical axis with respect to the distal end of the boom is described. US 2016/0054739 A1 describes an automatic control of the rotation of the grapple around the vertical axis with respect to the boom while the operator controls the movement of the distal end of the boom. The rotation angle of the grapple depends on the movement of the boom. For example, if logs are loaded into the forwarder, the grapple orientation will be rotated to be oriented transversely to the longitudinal axis of the logs when the grapple moves towards a pile of logs to be loaded and during movement towards the loading space, the grapple rotates such that the logs are parallel to the forward direction of the forwarder when they reach the loading space.

U.S. Pat. No. 11,937,554 B2 relates to automatic control of the rotation angle of the grapple around the vertical axis based on the position of the distal end of the boom. The rotation direction of the grapple can be automatically determined such that a collision with an obstacle (detected by a sensor) is avoided or the rotation direction with the shortest rotation angle is selected.

Wallin, E.; Wiberg, V.; Servin, M. Multi-Log Grasping Using Reinforcement Learning and Virtual Visual Servoing. Robotics 2024, 13, 3. https://doi.org/10.3390/robotics13010003, describe a simulated control of automatic loading logs into a forwarder using model-free reinforcement learning and virtual visual servoing for multi-log grasping, based among others on a virtual load cell in the rotator of the grapple sensing grapple-load weight (mass) that can be provided in practice by boom configuration and pressure in the hydraulic cylinder of the main boom.

The prior art thus describes some automation of the rotation of the grapple around the vertical axis, with automatic selection of the rotation direction based on avoidance of detected obstacles or simply using the rotation direction with the smallest angle. However, obstacle sensing requires approximate sensors, while the shortest rotation direction can be problematic for several reasons, among others due to possible obstacles.

Another problem of the prior art is a precise control of the rotation angle of the grapple. The hydraulic actuator is connected to a pump and a control valve, which is provided on the chassis of the forwarder, by relatively long hydraulic hoses, such that the pressure on the actuator varies with mechanical load acting onto the latter. The mechanical load on its end depends on the mass and inertia of the load, i.e. the log to be moved. The system is thus challenging to control and tends to be instable. The prior art as discussed above is silent on details of the control loop for the rotation of the grapple or uses a camera as a feedback sensor for controlling boom and grapple movement, which on its end is problematic in outdoor and in particular in forestry environments.

Therein lies an opportunity to avoid and reduce one or more of these challenges.

### SUMMARY OF THE DISCLOSURE

The present disclosure comprises a harvester with a crane, a harvester head, and an assembly positioned between a distal end of the crane and the harvester head. The assembly comprises a rotator for the harvester head. The rotator includes a stator, a rotor, and sensor. The stator is configured to be mounted to the distal end of the crane of the harvester head. The rotor is configured to be connected to a frame of the harvester head and rotate around an axis relative to the stator. The sensor is configured to detect an angular position of the rotor about the axis. The sensor is mounted to an intermediate flange between the rotor and the frame of the harvester head, and configured to interact with a reference element mounted on the stator.

The stator has a free end not covered by the rotor, and wherein the reference element is mounted on the free end adjacent the sensor. The reference element and the sensor are aligned on the axis. The intermediate flange includes openings configured to receive bolts that mount the frame of the harvester head to the rotor. The intermediate flange comprises a bottom, a wall surrounding the bottom, and a hollow interior, wherein the sensor is located within the hollow interior. The sensor is mounted to the bottom of the intermediate flange.

The reference element contains at least one magnet, and wherein the sensor is configured to sense a magnetic field generated by the magnet.

The rotation of the reference element relative to the sensor generates an output signal indicative of an angle of the rotor relative to the stator, wherein the reference element includes optical markings.

Other features and aspects will become apparent by consideration of the detailed description and accompanying drawings.

### BRIEF DESCRIPTION OF THE DRAWINGS

FIG. 1 is a side view of an embodiment of a forestry machine shown as a harvester.

FIG. 2 is a perspective view of a harvester head with a rotator, and

FIG. 3 is a vertical section through the rotator of the harvester head of the embodiment shown in FIG. 2 with a sensor flange.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments may include any combination of features from one or more dependent claims, and such features may be incorporated, collectively or separately, into any independent claim.

### DETAILED DESCRIPTION

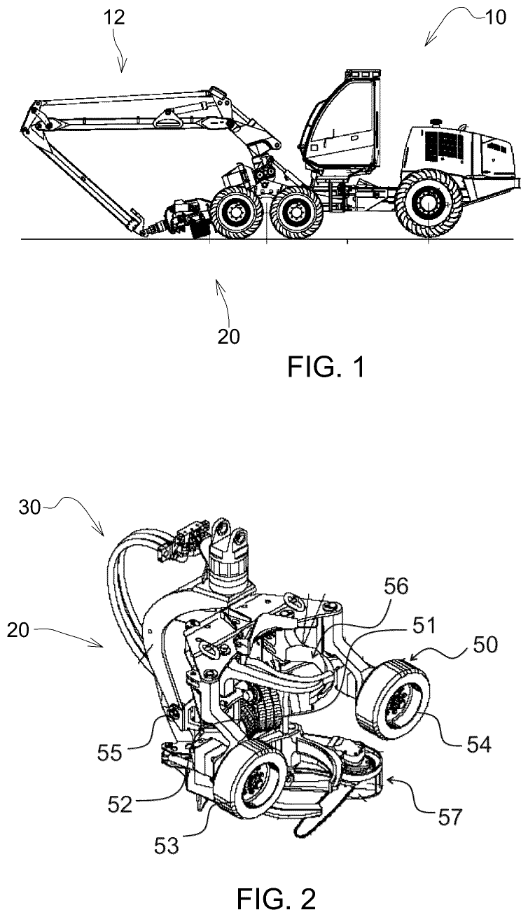

FIG. 1 shows a side view of a forestry machine of the type of a harvester 10 movable on a terrain. The harvester 10 comprises a crane 12 on the distal end of which a harvester head 20 is mounted.
FIG. 2 shows in more detail the harvester head 20, which is capable of performing cross-cutting and felling of a tree, feeding and delimbing of the tree trunk, as well as cross-cutting of the trunk to pieces of fixed length. The head 20 of FIG. 2 comprises a frame structure 55 which can be swiveled into different positions: the vertical position, as shown in FIG. 2, and the horizontal position; as well as a delimbing device 56, a feeding device 50, and a cross-cutting device 57.

The delimbing device 56 comprises at least two delimbing blades, normally placed in parallel and on opposite sides of the tree trunk. The feeding device 50 comprises at least two feeding members, normally placed in parallel and on opposite sides of the tree trunk. In the example of FIG. 2, the feeding device 50 comprises four feeding members which comprise two feed wheels 53, 54 and two feed rollers 51, 52 placed in the frame structure 55 and mechanically connected to each other.

Between the upper end of head 20, when the latter is in the position shown in FIG. 2, and the distal end of the crane 12, a rotator 30 is mounted, which allows to rotate head 20 with respect to the distal end of crane 12 around an axis, which is in the tree felling position of FIG. 2 vertical and in the transport position of FIG. 1 approximately horizontal. In the following description, it is assumed that the rotation axis 38 of rotator 30 is vertical and thus directional references, as axial or radial, are made with reference to a vertical rotation axis of rotator 30.

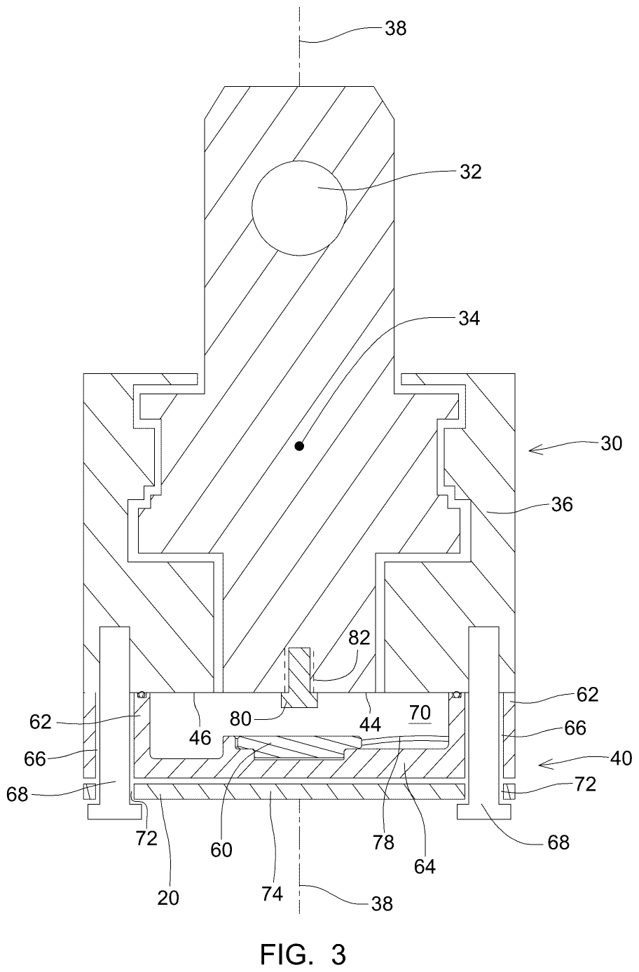

Reference is now made to FIG. 3, in which the rotator 30 and a sensor 60 are shown in a vertical section through rotator 30. The rotator 30 has an upper interface 32 for mounting the rotator 30 to the crane 12.

Rotator 30 comprises a stator 34 rigidly connected to or made unitary with the interface 32. Stator 34 thus does not rotate with respect to interface 32. Rotator 30 further has a rotor 36 surrounding the lower part of stator 34 circumferentially. Between stator 34 and rotor 36, one or more actuators (not shown) are provided for rotating rotor 36 around an axis 38 that is coincident with the longitudinal symmetry axis of rotator 30 and extends vertical in FIGS. 2 and 3. These actuators are generally driven hydraulically by radial piston motors, not shown in detail herein since known in the art.

The rotator 30 per se, without the intermediate flange 40 and sensor 60 as described below, is available for example from Black Bruin Oy, Jyväskylä, Finland. In the prior art, the frame of the head 20 is directly mounted to the bottom lower portion 46 of rotor 36. It should be noted that the lower end 44 of stator 34 is not covered by the lower portion 46 of rotor 36, such that the—thus free—lower end 44 of stator 34 is freely accessible from underneath, as can be seen in FIG. 3.

As also indicated in FIG. 3, on bottom 46 of rotor 36, an intermediate flange 40 is mounted. On the underside of intermediate flange 40, the frame 74 of head 20 is rigidly mounted by bolts 68 extending through openings 70 in frame 74 of head 20 and openings 66 within a wall 62 of flange 40. Bolts 68 thus mount frame 74 and flange 40 to rotor 36 of rotator 30.

Flange 40, as shown in FIG. 3, has a wall 62 extending circumferentially around a bottom 64, and thus a hollow interior 70 above bottom 64, surrounded by the wall 62. The openings 66, distributed around the circumference of flange 40, extend vertically through bottom 64 and wall 62. In mounted state, the bolts 68 are introduced into the openings 70 in frame 74 and the openings 66 in flange 40, having threads screwed into corresponding threaded bores in rotor 36 of the rotator 30.

On the bottom 64, within interior 70 of flange 40, a rotation sensor 60 is mounted. The sensor 60 is fixed by bolts on the bottom 64, be it directly or via an intermediate plate bolted to bottom 64 with the sensor 60 bolted to the intermediate plate. A cable 78 is routed from sensor 60 through the wall 62 (or bottom 64) towards head 20. Cable 78 is connected to an electronic control unit on head 20 which communicates, via electric lines provided between head 20 and harvester 10, with a control unit on the harvester 10. These electric lines can be routed through rotator 30 by rotary feedthroughs, like hydraulic lines for the head 20.

Sensor 60 is, in the shown embodiment, a magnetic sensor interacting with a reference element 80, which contains a magnet providing a magnetic field sensed by sensor 60. The reference element 80 is connected to the stator 34 of the rotator 30. Both the reference element 80 and the sensor 60 are aligned with the rotation axis 38 of rotator 30. The reference element 80 has an outer thread screwed into a bore 82 at the bottom of stator 34. A sensor 60 and reference element 80 are available from Curtiss-Wright Industrial Group, Christchurch, GB, part no. NRH27C. Rotation of element 80 with respect to sensor 60 and vice versa changes the orientation of the magnetic field within (and sensed by) sensor 60. Hence, sensor 60 provides an output signal on cable 78 indicating the angle of rotor 36 with respect to stator 34. In other embodiments, sensor 60 could interact with optical markings on reference element 80.

After all, it is apparent that the intermediate flange 40 is mounted between rotor 36 and frame 74 of head 20. Sensor 60 is mounted on bottom 64 of flange 40 and interacts with reference element 80 on stator 34 and provides an output signal indicating the rotation angle of rotor 36. Sensor 60 and reference element 80 are separate from rotator 30 and can be easily accessed for service.

What is claimed is:

1. An assembly comprising:
a rotator for a harvester head, the rotator comprising
a stator configured to be mounted to a distal end of a crane of a harvester head, and
a rotor configured to be connected to a frame of the harvester head and configured to rotate around an axis relative to the stator, and
a sensor configured to detect an angular position of the rotor about the axis,
wherein the sensor is mounted to an intermediate flange between the rotor and the frame of the harvester head, and configured to interact with a reference element mounted on the stator.

2. The assembly of claim 1, wherein the stator has a free end not covered by the rotor, and wherein the reference element is mounted on the free end adjacent the sensor.

3. The assembly of claim 1, wherein the reference element and the sensor are aligned on the axis.

4. The assembly of claim 1, wherein the intermediate flange includes openings configured to receive bolts that mount the frame of the harvester head to the rotor.

5. The assembly of claim 1, wherein the intermediate flange comprises a bottom, a wall surrounding the bottom, and a hollow interior, wherein the sensor is located within the hollow interior.

6. The assembly of claim 5, wherein the sensor is mounted to the bottom of the intermediate flange.

7. The assembly of 1, wherein the reference element contains at least one magnet, and wherein the sensor is configured to sense a magnetic field generated by the magnet.

8. The assembly of claim 6, wherein a rotation of the reference element relative to the sensor generates an output signal indicative of an angle of the rotor relative to the stator, wherein the reference element includes optical markings.

9. A harvester comprising:
a crane;
a harvester head; and
an assembly positioned between a distal end of the crane and the harvester head, wherein the assembly comprises:
a rotator for a harvester head, the rotator comprising
a stator configured to be mounted to the distal end of the crane of the harvester head, and
a rotor configured to be connected to a frame of the harvester head and rotate around an axis relative to the stator, and
a sensor configured to detect an angular position of the rotor about the axis,
wherein the sensor is mounted to an intermediate flange between the rotor and the frame of the harvester head, and configured to interact with a reference element mounted on the stator.

10. The harvester of claim 9, wherein the stator has a free end not covered by the rotor, and wherein the reference element is mounted on the free end adjacent the sensor.

11. The harvester of claim 9, wherein the reference element and the sensor are aligned on the axis.

12. The harvester of claim 9, wherein the intermediate flange includes openings configured to receive bolts that mount the frame of the harvester head to the rotor.

13. The harvester of claim 9, wherein the intermediate flange comprises a bottom, a wall surrounding the bottom, and a hollow interior, wherein the sensor is located within the hollow interior.

14. The harvester of claim 13, wherein the sensor is mounted to the bottom of the intermediate flange.

15. The harvester of 9, wherein the reference element contains at least one magnet, and wherein the sensor is configured to sense a magnetic field generated by the magnet.

16. The harvester of claim 14, wherein a cable is routed from the sensor through the wall or bottom towards head and connected to an electronic control unit on head which communicates, via electric lines provided between head and harvester, with a control unit on the harvester.

17. The harvester of claim 14, wherein a rotation of the reference element relative to the sensor generates an output signal indicative of an angle of the rotor relative to the stator, wherein the reference element includes optical markings.
